(19) United States
(12) Patent Application Publication
(10) Pub. No.: US 2023/0300547 A1
(43) Pub. Date: Sep. 21, 2023

(54) METHOD FOR OPERATING A HEARING AID AND HEARING AID

(71) Applicant: Sivantos Pte. Ltd., Singapore (SG)

(72) Inventor: Umut Gökay, Erlangen (DE)

(21) Appl. No.: 18/187,120

(22) Filed: Mar. 21, 2023

(30) Foreign Application Priority Data
Mar. 21, 2022 (DE) 10 2022 202 713.2

(51) Int. Cl. H04R 25/00

(52) U.S. Cl. CPC H04R 25/65; H04R 25/402; H04R 25/604; H04R 2225/41; H04R 2460/11

(57) ABSTRACT

A method operates a hearing aid having a housing insertable into an outer auditory canal and has proximal and distal sides. The proximal side is oriented toward an eardrum and includes a proximal input transducer, and a distal input transducer is disposed on the distal side. An output transducer is disposed on the proximal side and an adjustable vent penetrates the housing. An evaluation unit is provided, and an adjustment process is carried out to adjust the vent. In the course of the adjustment process, a set of transmission functions is determined by the evaluation unit, and includes a distal transmission function, which maps a signal path from the output transducer to the distal input transducer, and a proximal transmission function, which maps a signal path from the output transducer to the proximal input transducer.

### CROSS-REFERENCE TO RELATED APPLICATION

This application claims the priority, under 35 U.S.C. § 119, of German Patent Application DE 10 2022 202 713.2, filed Mar. 21, 2022; the prior application is herewith incorporated by reference in its entirety.

### FIELD AND BACKGROUND OF THE INVENTION

The invention relates to a method for operating a hearing aid. In addition, the invention relates to a hearing aid.

Typically, classic hearing aids, which are used to care for the hard of hearing, are referred to as hearing aids. However, in the broader meaning this term also refers to devices which are configured to assist persons having normal hearing. Hearing aids for assisting persons having normal hearing are also designated as “Personal Sound Amplification Products” or “Personal Sound Amplification Devices” (abbreviated: “PSAD”). Such hearing aids, in contrast to classic hearing aids, are not provided to compensate for hearing losses, but are used deliberately to assist and improve the normal human sense of hearing in specific hearing situations.

Independently of the provided intended use, hearing aids typically include at least one input transducer, a signal processing device, and an output transducer as essential components. The at least one input transducer is generally formed here by an acoustoelectric transducer, thus, for example, by a microphone, or by an electromagnetic receiver, for example an induction coil. In many cases, multiple input transducers are furthermore installed, thus, for example, one or more acoustoelectric transducers and an electromagnetic receiver. An electroacoustic transducer is typically used as the output transducer, for example a miniature loudspeaker (which is also referred to as a “receiver”), or an electromechanical transducer, for example a bone vibrator. The signal processing device is generally formed by an electronic circuit implemented on a circuit board and independently thereof typically has an amplifier.

Furthermore, typically two basic types of structures or designs are distinguished in hearing aids. Hearing aids of the one basic type are referred to as behind-the-ear hearing aids, abbreviated BTE hearing aids, and hearing aids of the other basic type are referred to as in-the-ear hearing aids, abbreviated ITE hearing aids. BTE hearing aids include in this case, in addition to a main module, which is worn behind the ear, an earpiece connected to the main module, which is provided for placement in an outer auditory canal. In the case of ITE hearing aids, in contrast, the hearing aid as a whole is inserted for use into an outer auditory canal.

In order that an air exchange can still take place between the auditory canal and the surroundings even with inserted earpiece or hearing aid, corresponding earpieces or hearing aids include a so-called vent in some cases. This is a bore or a channel which penetrates the earpiece or the ITE hearing aid and through which an air exchange and thus in particular also a pressure equalization can take place.

A corresponding vent is accompanied by both advantages and disadvantages. On the one hand, for example, the risk of inflammations in the auditory canal may be reduced by a corresponding vent. In addition, so-called occlusion effects, which are typically perceived as unpleasant, may be reduced or avoided. On the other hand, soundwaves which are generated by the hearing aid and emitted into the auditory canal can also escape through a corresponding vent. Therefore, in particular lower frequencies typically have to be emitted additionally amplified into the auditory canal. Moreover, undesired feedback is enabled or amplified by a corresponding vent.

### SUMMARY OF THE INVENTION

Proceeding therefrom, the invention is based on the object of specifying an advantageous method for operating a hearing aid and an advantageously designed hearing aid.

This object is achieved according to the invention by a method having the features of the independent method claim and by a hearing aid having the features of the independent hearing aid claim. The dependent claims contain preferred refinements. The advantages and preferred embodiments listed with respect to the method are also transferable accordingly to the hearing aid and vice versa.

With the foregoing and other objects in view there is provided, in accordance with the invention, a method for operating a hearing aid having a housing configured for being inserted into an outer auditory canal and with a proximal side and a distal side opposite to the proximal side. The proximal side is configured to be oriented toward an eardrum and a proximal input transducer is disposed on the proximal side of the housing and a distal input transducer is disposed on the distal side of the housing. The hearing aid further has an output transducer on the proximal side of the housing, an adjustable vent which penetrates the housing, and a control and evaluation unit. The method includes the steps of carrying out an adjustment process to adjust the adjustable vent and wherein in a course of the adjustment process a set of transmission functions is determined by means of the control and evaluation unit. The set includes at least two transmission functions, namely a distal transmission function, which maps a signal path from the output transducer to the distal input transducer, and a proximal transmission function, which maps a signal path from the output transducer to the proximal input transducer.

The method according to the invention is used here to operate a hearing aid, in particular a classic hearing aid, and is accordingly configured for this purpose. Vice versa, a hearing aid according to the invention is preferably configured as a classic hearing aid and configured in such a way that the method according to the invention is executable thereby and is also executed in at least one operating mode.

In this case, the hearing aid includes a housing, which is configured to be inserted into an outer auditory canal of a user and which includes a proximal side and a distal side opposite to the proximal side. The proximal side is then configured to be oriented toward an eardrum and accordingly the housing is then typically also arranged after being inserted into an outer auditory canal in such a way that the proximal side faces toward an eardrum and the distal side faces outward, thus out of the outer auditory canal.

Depending on the application, the hearing aid is furthermore configured as a behind-the-ear hearing aid, abbreviated BTE hearing aid, or as an in-the-ear hearing aid, abbreviated ITE hearing aid. If the hearing aid is configured as a BTE hearing aid, the above-mentioned housing is then part of an earpiece which is connected to a main module. This main module expediently also includes a housing here. In contrast, if the hearing aid is configured as an ITE hearing aid, the above-mentioned housing is thus a housing which terminates the entire hearing aid to the outside.

Independently thereof, the hearing aid includes a proximal input transducer on the proximal side of the housing and a distal input transducer on the distal side of the housing. Each of these input transducers is used here to generate electrical input signals based on acoustic input signals which are incident on the hearing aid. For this purpose, each input transducer expediently has an acoustoelectric transducer, thus in particular at least one microphone. The electrical input signals generated by means of the proximal input transducer are designated hereinafter as proximal input signals and the electrical input signals generated by means of the distal input transducer are designated hereinafter as distal input signals.

Furthermore, the hearing aid includes an output transducer on the proximal side of the housing. This is used to generate acoustic output signals based on electrical output signals and expediently includes an electroacoustic transducer, thus, for example, a loudspeaker. The electrical output signals are referred to in brief hereinafter as output signals.

The input transducers and the output transducer are supplemented by a signal processing device, which is configured to generate electrical output signals based on electrical input signals. In operation of the hearing aid, the distal input signals generated by means of the distal input transducer are then typically processed in the signal processing device, wherein output signals are generated based on the distal input signals. Finally, acoustic output signals are generated by the output transducer based on these (electrical) output signals and emitted on the output side by the hearing aid, specifically in particular into an outer auditory canal of a hearing aid wearer or user. In this way, an amplification is then typically implemented according to a principle known per se.

Furthermore, the hearing aid includes a vent described at the outset, which penetrates the above-mentioned housing. The vent is configured in this case as an adjustable vent, thus a vent having changeable or adjustable geometric parameters. In particular an opening cross section of the vent is changeable here. Such an adjustable vent is also sometimes designated as a controllable, active, or adaptive vent.

According to the invention, the hearing aid additionally includes a control and evaluation unit and is configured to carry out an adjustment process for adjusting the vent in at least one operating mode. In the course of the adjustment process, a set of transmission functions is determined by means of the control and evaluation unit, which set includes at least two transmission functions, namely a distal transmission function, which maps a signal path from the output transducer to the distal input transducer, and a proximal transmission function, which maps a signal path from the output transducer to the proximal input transducer.

The determined set of transmission functions is then typically evaluated further in the control and evaluation unit and a suitable setting for the vent is then preferably determined based on this evaluation, wherein the setting of the vent is adjusted when the determined suitable setting does not correspond to the current setting. I.e., at least one geometric parameter of the vent is then changed.

Two signals are preferably compared to one another to determine each transmission function. The current distal input signal and the current output signal are expediently compared to one another in the case of the distal transmission function and the current proximal input signal and the current output signal are compared to one another in the case of the proximal transmission function. Furthermore, each transmission function is preferably a mapping function. In this case, the distal transmission function expediently maps the current output signal on the current distal input signal and the proximal transmission function maps the current output signal on the current proximal input signal.

Furthermore, an embodiment is advantageous in which the set of transmission functions includes a first distal transmission function, which maps a signal path from the output transducer to the distal input transducer with completely open vent, and a second distal transmission function, which maps a signal path from the output transducer to the distal input transducer with completely closed vent.

The two distal transmission functions are expediently determined in succession in this case, wherein the setting of the vent is changed between the determination of the first distal transmission function and the determination of the second distal transmission function. The vent is thus completely open once, namely during the determination of the first distal transmission function, and completely closed once, namely during the determination of the second distal transmission function, which takes place before or after the determination of the first distal transmission function.

Independently thereof, the two settings completely open and completely closed stand for two extremes with regard to the geometric parameters of the vent, and in particular for two extremes with regard to the opening cross section of the vent.

Alternatively or additionally, for the set of transmission functions, at least one distal transmission function is determined which maps a signal path from the output transducer to the digital input transducer with a partially open vent, thus with a setting between the two extremes.

According to a further advantageous embodiment, the set of transmission functions includes a first proximal transmission function, which maps a signal path from the output transducer to the proximal input transducer with completely open vent, and a second proximal transmission function, which maps a signal path from the output transducer to the proximal input transducer with completely closed vent.

The two proximal transmission functions are expediently determined in succession here, wherein the setting of the vent is changed between the determination of the first proximal transmission function and the determination of the second proximal transmission function. The vent is thus completely open once, namely during the determination of the first proximal transmission function, and completely closed once, namely during the determination of the second proximal transmission function, which takes place before or after the determination of the first proximal transmission function.

Alternatively or additionally, for the set of transmission functions, at least one proximal transmission function is determined, which maps a signal path from the output transducer to the proximal input transducer with a partially open vent, thus with a setting between the two extremes.

In addition, an embodiment is advantageous in which the set of transmission functions includes a distal-proximal transmission function, which maps a signal path from the distal input transducer to the proximal input transducer. To determine this distal-proximal transmission function, typically the current distal input signal and the current proximal input signal are compared to one another and preferably the distal-proximal transmission function maps the current distal input signal on the current proximal input signal.

In an advantageous refinement, the set of transmission functions includes a first distal-proximal transmission function, which maps a signal path from the distal input transducer to the proximal input transducer with completely open vent, and a second distal-proximal transmission function, which maps a signal path from the distal input transducer to the proximal input transducer with completely closed vent.

The two distal-proximal transmission functions are expediently determined in succession in this case, wherein the setting of the vent is changed between the determination of the first distal-proximal transmission function and the determination of the second distal-proximal transmission function. The vent is thus completely open once, namely during the determination of the first distal-proximal transmission function, and completely closed once, namely during the determination of the second distal-proximal transmission function, which takes place before or after the determination of the first distal-proximal transmission function.

Alternatively or additionally, for the set of transmission functions, at least one distal-proximal transmission function is determined, which maps a signal path from the distal input transducer to the proximal input transducer with a partially open vent, thus with a setting between the two extremes.

As already indicated above, a control signal is expediently generated in the course of the adjustment process by means of the control and evaluation unit based on the set of transmission functions. I.e., typically the transmission functions of the set of transmission functions are evaluated and a control signal is generated based on this evaluation. The hearing aid is then furthermore preferably configured in such a way that an adjusting device of the vent is activated by this control signal, so that at least one geometric parameter of the vent is adjusted automatically by the adjusting device.

The at least one geometric parameter is then expediently either changed or it is left unchanged by such a control signal. If the control signal thus corresponds to a voltage, for example, voltage values of nonzero and zero are thus possible, wherein the at least one geometric parameter is then changed in the event of a nonzero voltage and remains unchanged in the event of a voltage equal to zero. According to an alternative, the control signal is given by a voltage, wherein the at least one geometric parameter is changed in case of a change of the voltage and remains unchanged in case of constant voltage.

Furthermore, different embodiments are provided for the adjusting device of the vent depending on the application. In principle, all embodiments are expedient here which may be activated via a control signal, in particular an above-described electrical signal, in which at least one geometric parameter of a vent may thus be changed by means of a control signal. Examples of such embodiments are found for this purpose in the prior art.

Embodiments are also expedient, for example, in which the adjusting device includes a piezo-crystal unit, the extension of which is variable by an applied voltage. This piezo-crystal unit is then used, for example, for displacing a closure element, thus, for example, a closure element having conical basic geometry. Alternatively, the piezo-crystal unit itself is used as a closure element and protrudes for this purpose at least partially into the vent depending on the status and thus at least partially closes the vent. In both cases, the effective opening cross section of the vent may then be variably set by a variation of the voltage.

According to an additionally preferred embodiment, at least three settings are specifiable using the adjusting device of the vent, namely a setting in which the vent is completely open, a setting in which the vent is completely closed, and at least one setting in which the vent is partially open. Furthermore preferably, at least three and in particular at least five distinguishable settings are specifiable, in which the vent is partially open in each case, but in which in particular different opening cross sections are implemented.

Furthermore, it is expedient if a reference function is specified for each transmission function in the set of transmission functions. In this case, a control signal is then preferably generated in the course of the adjustment process by means of the control and evaluation unit in such a way that the transmission functions, thus the current transmission functions, at least approximate their reference functions.

According to at least one embodiment, the adjustment process is moreover designed as a regulating process. This is advantageous in particular if, as described above, an approximation of the transmission functions to reference functions is provided. In this case, a step-by-step or continuous approximation of the transmission functions of the set of transmission functions to their reference functions is then preferably implemented by means of the regulating process. A corresponding regulating process runs permanently in the background in this case depending on the application, for example. Alternatively, it is ensured that the regulating process ends according to a specification, thus, for example, after a specified number of control loops or control cycles or, for example, after a specified period of time.

In particular if the above-described adjustment process is not a regulating process running permanently in the background, it is additionally advantageous if multiple adjustment processes are carried out automatically. The adjustment processes are expediently spaced apart over time. It is to be considered here that when wearing the hearing aid, the seat of the hearing aid sometimes changes in the course of time, so that the seat is sometimes better and sometimes worse. Since the seat influences the transmission functions, it is then expedient to repeat the adjustment process at certain time intervals, if it is not permanently executed as a regulating process.

According to an advantageous refinement, the time intervals between the adjustment processes are automatically adjusted here, thus, for example, at a power consumption controller. If multiple operating modes are provided for the hearing aid, for example, in which different specifications are present with regard to the maximum permissible consumption of electrical energy, the frequency of the adjustment processes is thus specified in dependence on these operating modes.

According to a further embodiment variant, the adjustment process is automatically carried out once after each time the hearing aid is switched on.

Alternatively or additionally, the hearing aid is configured for a manual start of the adjustment process. I.e., the adjustment process can be started, for example, via a button and/or by means of a remote control and is also started upon corresponding actuation.

Independently thereof, the above-described adjustment process is furthermore preferably used to implement a preset of the vent for other processes or algorithms, in particular for processes or algorithms which run permanently in the background or are permanently executed in operation of the hearing aid or at least in one operating mode of the hearing aid.

One example of such a different, further, or additional algorithm is a so-called feedback canceler. Such a feedback canceler is used to suppress undesired feedback. Acoustic feedback often occurs in hearing aids, in particular if these are devices having high amplification. This feedback is typically expressed in strong oscillations of a specific frequency and is typically perceived as whistling. This whistling is generally very unpleasant both for the hearing aid wearer themself and also for persons in their immediate environment. Feedback can occur in particular if sound which is recorded via a microphone of the hearing aid is amplified by a signal amplifier and output via a loudspeaker, also called a receiver, reaches the microphone again and is amplified again.

An array of adaptive algorithms, namely so-called feedback cancelers, have already been developed for dynamic reduction of feedback, which preferably adjust automatically to the respective feedback situation and effectuate corresponding measures. Some of these algorithms enable the detection of feedback, thus in particular the feedback whistling, wherein typically at least one input signal of a microphone is continuously monitored for feedback and in particular feedback oscillations for this purpose. If feedback and in particular feedback-typical oscillations are detected, thus, for example, the hearing aid amplification is reduced enough at the corresponding point that the loop amplification sinks below a critical limit. This amplification reduction can be carried out, for example, by reducing a frequency channel or by activating a suitable narrowband blocking filter (notch filter). In the feedback cancelers considered here, additionally or alternatively to the reduction of hearing aid amplification, an adjustment of the adjustable vent takes place when feedback is detected. The above-described adjustment process according to the invention is then used to implement a preset of the vent, from which the adjustment by the feedback canceler takes place, thus the adjustment in dependence on the feedback detection.

The preset typically takes place in such a way that the vent, thus in particular the effective opening cross section of the vent, is adjusted in the course of the adjustment process to a current base setting or middle position, which is thus dependent on the above-described adjustment process, from which a further adjustment, in particular a fine adjustment, then takes place in dependence on at least one further algorithm, thus, for example, in dependence on an above-mentioned feedback canceler.

Described concisely and in simplified form, the adjustment process according to the invention described here is thus used to adjust an adjustable vent of a hearing aid. A signal analysis is expediently carried out in the course of the adjustment process, in which at least the input signals of two microphones of the hearing aid are evaluated, which are located on opposite sides of a housing insertable into an auditory canal, thus an inner or proximal microphone and an outer or distal microphone.

The signal analysis carried out typically contains two or more of the following partial analyses or analysis areas depending on the embodiment variant:
analysis of the (signal) path or the transmission function from the outer to the inner microphone,
analysis of the (signal) path or the transmission function from the inner to the outer microphone,
analysis of the (signal) path from the loudspeaker or receiver to the inner microphone,
analysis of the (signal) path from the loudspeaker or receiver to the outer microphone, and
analysis of at least one signal of at least one further sensor to predict changes, thus, for example, a movement sensor or acceleration sensor, a gyroscope, and/or a compass, etc.

One parameter determined and/or evaluated in the course of such an analysis is, for example, the difference of a sound pressure level at the moment of the measurement using proximal and distal microphone in a specified frequency band.

Based on the signal analysis carried out, a control signal is then expediently generated, using which the vent is activated and, in this way, adjusted. This adjustment is preferably used here as a preset of the vent for other processes or algorithms.

In particular the following concepts underlie this. The sound pressure level is compared proximally and distally with observation of an audiogram of a hearing aid wearer or patient. This preferably takes place with the goal that proximally, at least minus the amplification by the hearing aid, and distally the same sound pressure level is to be provided. This is because the most open possible hearing experience is to be achieved, but at the same time sufficient amplification is also to be achieved.

A threshold value or threshold is then preferably calculated. This threshold value is incorporated, for example, as a “large signal” or offset in the control of the vent and is thus used for the preset. The remaining signal processing/control then furthermore preferably takes place around the offset. That is to say, a base value is more or less found for a “middle position” for the vent preferably by a comparison of the sound pressure level proximal and distal and all further adaptations continue on the basis of the above-mentioned path measurements.

Other features which are considered as characteristic for the invention are set forth in the appended claims.

Although the invention is illustrated and described herein as embodied in a method for operating a hearing aid and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side view of a hearing aid having a main module and an earpiece; and

FIG. 2 is a partial section illustration of the earpiece.

### DETAILED DESCRIPTION OF THE INVENTION

Parts corresponding to one another are provided with the same reference signs in all figures.

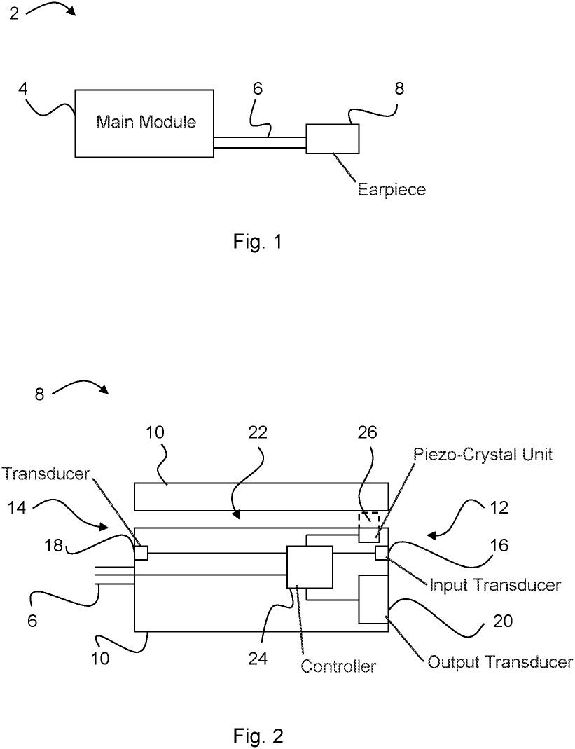

Referring now to the figures of the drawings in detail and first, particularly to FIG. 1 thereof, there is shown a hearing aid 2, which is described by way of example hereinafter, is configured as a behind-the-ear hearing aid 2, abbreviated BTE hearing aid. It includes a main module 4, which is configured to be worn behind an ear, and an earpiece 8 connected to the main module 4 via a cable 6.

The earpiece 8 is schematically shown in an illustration in partial section in FIG. 2 and includes a housing 10, which terminates the earpiece 8 to the outside and which is designed to be inserted into an outer auditory canal. The housing 10 furthermore includes a proximal side 12 and a distal side 14 opposite to the proximal side 12. The proximal side 12 is then designed to be oriented toward an eardrum and accordingly the housing 10 is typically also arranged after being inserted into an outer auditory canal in such a way that the proximal side 12 faces toward an eardrum and the distal side faces outward, thus out of the outer auditory canal.

Furthermore, the hearing aid 2 includes a proximal input transducer 16 on the proximal side 12 of the housing 10 and a distal input transducer 18 on the distal side 14 of the housing 10. Each of these input transducers is used to generate electrical input signals based on acoustic input signals which are incident on the hearing aid 2. In the exemplary embodiment, each of these input transducers includes at least one microphone. The electrical input signals generated by means of the proximal input transducer 16 are referred to hereinafter as proximal input signals and the electrical input signals generated by means of the distal input transducer 18 are referred to hereinafter as distal input signals.

Moreover, the hearing aid 2 includes an output transducer 20 on the proximal side 12 of the housing 10. This is used for generating acoustic output signals based on electrical output signals and is formed in the exemplary embodiment by a loudspeaker. The electrical output signals are referred to in short hereinafter as output signals.

Moreover, a further input transducer (not shown) having at least one microphone and a signal processing device (not explicitly shown) are arranged in the main module 4 in the exemplary embodiment. By means of the further input transducer and the signal processing device, in operation of the hearing aid 2, the input signals generated by means of the further input transducer are processed in the signal processing device, wherein output signals are generated based on these input signals. Finally, acoustic output signals are generated by the output transducer 20 based on these (electrical) output signals and emitted on the output side from the earpiece 8, in particular into an outer auditory canal of a hearing aid wearer. In this way, an amplification according to a principle known per se is then typically implemented.

Furthermore, the hearing aid 2 includes a vent 22, which penetrates the above-mentioned housing 10 of the earpiece 8. The vent 22 is configured in this case as an active or adjustable vent 22, thus as a vent 22 having changeable or adjustable geometric parameters. The opening cross section of the vent 22 is changeable in the exemplary embodiment.

In addition, the hearing aid 2 includes a control and evaluation unit 24, which is arranged in the earpiece 8. This is configured to carry out an adjustment process for adjusting the vent 22 in at least one operating mode, and for this purpose is connected for signaling to both the proximal input transducer 16 and the distal input transducer 18.

A set of transmission functions is determined in the course of the adjustment process by means of the control and evaluation unit 24, which set comprises a distal transmission function, which maps a signal path from the output transducer 20 to the distal input transducer 18, and a proximal transmission function, which maps a signal path from the output transducer 20 to the proximal input transducer 16.

The determined set of transmission functions is then further evaluated in the control and evaluation unit 24 and a suitable setting for the vent 22 is determined based on this evaluation. In dependence on the determined suitable setting for the vent 22, a control signal is generated by the control and evaluation unit 24, using which an adjusting device of the vent 22 is activated.

In the exemplary embodiment, this adjusting device includes a piezo-crystal unit 26, the extension of which is variable by an applied voltage, thus by the control signal of the control and evaluation unit 24. The piezo-crystal unit 26 protrudes at least partially into the vent 22 in this case depending on the status and thus at least partially closes the vent 22. As a result, the opening cross section of the vent 22 may be variably adjusted by a variation of the voltage. The two extremes for the adjustment of the opening cross section are indicated in FIG. 2. The dashed frame indicates a setting in which the vent 22 is completely closed, and the frame having solid lines indicates a setting in which the vent 22 is completely open. In the exemplary embodiment, multiple further settings are moreover specifiable, in which the vent 22 is partially open.

The above-described adjustment process is preferably carried out once automatically after each time the hearing aid 2 is switched on. Alternatively or additionally, the hearing aid 2 is configured for a manual start of the adjustment process. I.e., the adjustment process can be started, for example, via a button (not shown) and/or by means of a remote control (not shown) and is also started upon corresponding actuation.

The following is a summary list of reference numerals and the corresponding structure used in the above description of the invention.

List of Reference Numerals

| | |
|---|---|
| 2 | hearing aid |
| 4 | main module |
| 6 | cable |
| 8 | earpiece |
| 10 | housing |
| 12 | proximal side |
| 14 | distal side |
| 16 | proximal input transducer |
| 18 | distal input transducer |
| 20 | output transducer |
| 22 | vent |
| 24 | control and evaluation unit |
| 26 | piezo-crystal unit |

1. A method for operating a hearing aid having a housing configured for being inserted into an outer auditory canal and with a proximal side and a distal side opposite to the proximal side, wherein the proximal side is configured to be oriented toward an eardrum and having a proximal input transducer on the proximal side of the housing and a distal input transducer on the distal side of the housing, the hearing aid further having an output transducer on the proximal side of the housing, an adjustable vent which penetrates the housing, and a control and evaluation unit, which comprises the steps of:
carrying out an adjustment process to adjust the adjustable vent and wherein in a course of the adjustment process a set of transmission functions is determined by means of the control and evaluation unit, which set includes at least two transmission functions, namely a distal transmission function, which maps a signal path from the output transducer to the distal input transducer, and a proximal transmission function, which maps a signal path from the output transducer to the proximal input transducer.

2. The method according to claim 1, wherein the set of transmission functions includes:
a first distal transmission function, which maps a signal path from the output transducer to the distal input transducer with the adjustable vent completely open; and
a second distal transmission function, which maps a signal path from the output transducer to the distal input transducer with the adjustable vent completely closed.

3. The method according to claim 1, wherein the set of transmission functions includes:
a first proximal transmission function, which maps a signal path from the output transducer to the proximal input transducer with the adjustable vent completely open; and
a second proximal transmission function, which maps a signal path from the output transducer to the proximal input transducer with the adjustable vent completely closed.

4. The method according to claim 1, wherein the set of transmission functions includes a distal-proximal transmission function, which maps a signal path from the distal input transducer to the proximal input transducer.

5. The method according to claim 1, wherein the set of transmission functions includes:
a first distal-proximal transmission function, which maps a signal path from the distal input transducer to the proximal input transducer with the adjustable vent completely open; and
a second distal-proximal transmission function, which maps a signal path from the distal input transducer to the proximal input transducer with the adjustable vent completely closed.

6. The method according to claim 1, wherein:
in a course of the adjustment process, a control signal is generated by means of the control and evaluation unit based on the set of transmission functions; and
an adjusting device of the adjustable vent is activated by the control signal, so that at least one geometric parameter of the adjustable vent is automatically adjusted by the adjusting device.

7. The method according to claim 6, wherein at least three settings are specifiable by means of the adjusting device of the adjustable vent, namely a setting in which the adjustable vent is completely open, a setting in which the adjustable vent is completely closed, and at least one setting in which the adjustable vent is partially open.

8. The method according to claim 6, wherein a reference function is specified for each transmission function in the set of transmission functions and wherein the control signal is generated in the course of the adjustment process by means of the control and evaluation unit in such a way that the transmission functions approximate reference functions.

9. The method according to claim 8, wherein the adjustment process is configured as a regulating process.

10. The method according to claim 1, which further comprises carrying out a plurality of adjustment processes automatically and wherein time intervals between the adjustment processes are automatically adapted at a power consumption controller.

11. The method according to claim 1, wherein the adjustment process is manually started.

12. A hearing aid configured to execute a method according to claim 1 in at least one operating mode.
